(19) United States
(12) Patent Application Publication
(10) Pub. No.: US 2010/0082629 A1
(43) Pub. Date: Apr. 1, 2010

(54) SYSTEM FOR ASSOCIATING DATA ITEMS WITH CONTEXT

(75) Inventors: Marc Davis, San Francisco, CA (US); Jeonghee Yi, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/239,982

(22) Filed: Sep. 29, 2008

(51) Int. Cl. G06F 7/06; G06F 17/30

(52) U.S. Cl. 707/741; 707/E17.014; 707/E17.044

(57) ABSTRACT

A system is described for associating data items with context. The system may include a processor, a memory and an interface. The processor may identify an action performed by a user and may determine the spatial, temporal, social and topical attributes of the action. The spatial attribute of the action may relate to the user's location, the temporal attribute may relate to the time the action was performed, the social attribute may relate to a social relation of the user, and the topical attribute may relate to a topic of interest to the user. The processor may store an association between a descriptor of the action, the spatial attribute of the action, the temporal attribute of the action, the social attribute of the action and the topical attribute of the action in the memory. The processor may use the stored association to provide a contextually relevant data item via the interface.

### TECHNICAL FIELD

The present description relates generally to a system and method, generally referred to as a system, for associating data items with context, and more particularly, but not exclusively, to building data stores of contextually relevant data items.

### BACKGROUND

The mobile phone may be increasingly important as an information and content access device. Currently there may be twice as many mobile communication devices as personal computers. Mobile operators may be increasingly looking to high value data services as a way to overcome the continuing voice average revenue per user (“ARPU”) decline. As consumer adoption of wireless technology continues to increase, advertising via mobile devices may become an important part of all integrated data communications strategies.

### SUMMARY

A system is disclosed for providing building a data store of contextually relevant data items. The system may include a processor, a memory and an interface. The memory may be operatively connected to the processor and the interface and may store an association between a descriptor of an action performed by a user, a spatial attribute of the action, a temporal attribute of the action, a social attribute of the action and a topical attribute of the action. The interface may provide contextually relevant data items. The processor may identify the action performed by the user and may determine the spatial, temporal, social and topical attributes of the action. The spatial attribute of the action may relate to the location of the user. The temporal attribute of the action may relate to the time when the user performed the action. The social attribute of the action may relate to a social relation of the user. The topical attribute may relate to a topic of interest to the user. The processor may store an association between a descriptor of the action performed by the user, the spatial attribute of the action, the temporal attribute of the action, the social attribute of the action and the topical attribute of the action in the memory. The processor may use the stored association to provide a contextually relevant data item via the interface.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for associating data items with context.

FIG. 2 is block diagram of a simplified view of a network environment implementing the system of FIG. 1 or other systems for associating data items with context.

FIG. 3 is a block diagram of an implementation of the system of FIG. 1 or other systems for associating data items with context.

FIG. 4 is a block diagram of a workflow of the system of FIG. 1 or other systems for associating data items with context.

FIG. 5 is an illustration of exemplary contextual attributes associated with a user click action in the system of FIG. 1, or other systems for associating data items with context.

FIG. 6 is a flowchart illustrating operations of associating data items with context in the system of FIG. 1, or other systems for associating data items with context.

FIG. 7 is a flowchart illustrating operations of building a contextual data store in the system of FIG. 1, or other systems for associating data items with context.

FIG. 8 is a flowchart illustrating operations of generating contextual models in the system of FIG. 1, or other systems for associating data items with context.

FIG. 9 is a flowchart illustrating operations of providing contextually relevant search results in the system of FIG. 1 or other systems for associating data items with context.

FIG. 10 is an illustration a general computer system that may be used in a system for associating data items with context.

### DETAILED DESCRIPTION

A system and method, generally referred to as a system, relate to associating data items with context, and more particularly, but not exclusively, to building data stores of contextually relevant data items. The principles described herein may be embodied in many different forms.

The system may allow a service provider to provide search results and/or advertisements that are relevant to the context of a query. The context may be determined by one or more contextual attributes, such as a spatial attribute, a temporal attribute, a social attribute, or a topical attribute. The system may allow the service provider to retrieve the contextually relevant search results and rank the search results based on their relevancy to the context of the search query. The search results most relevant to the context of the search query may be provided to the user. The system may provide an advantage over prior art systems by incorporating the context specific to an individual query into the selection of search results, thereby providing more relevant search results to the user.

The system may allow a service provider to build a data store of contextual user behavior data. The data store may include data items describing the actions of a user and the context the action was performed in. Each data item describing an action of the user may be associated with one or more contextual attributes describing the context. The contextual attributes may include a spatial attribute, a temporal attribute, a social attribute and a topical attribute. The spatial attribute may describe the location of the user while performing the action. The temporal attribute may describe the time when the user performed the action. The social attribute may describe the behavior of users socially connected to the user. The topical attribute may describe topics of interest the user has recently expressed interest in. The system may store an association between the action and the contextual attributes in a contextual user behavior data store. The user behavior data store may then be used to determine and provide contextually relevant data items.

The system may allow a service provider to build contextual user behavior models. Each model may reflect the behavior of a user when the user's context falls within the context represented by the model. The system may build a model for each context identified in a user behavior data store. The models may be used to provide data to a user which is relevant to the context of the user.

The system may allow a service provider to provide contextually relevant search results. The system may build a data store of contextual user behavior data and may generate contextual user behavior models based on the data store. The system may receive a search query from a user and may determine the context in which the query was performed. The system may retrieve the contextual model correlating to the context in which the query was performed. The contextual model may be used to determine the search results relating to the search query which are relevant to the context the query was performed in. The search results most relevant to the context may be provided to the user.

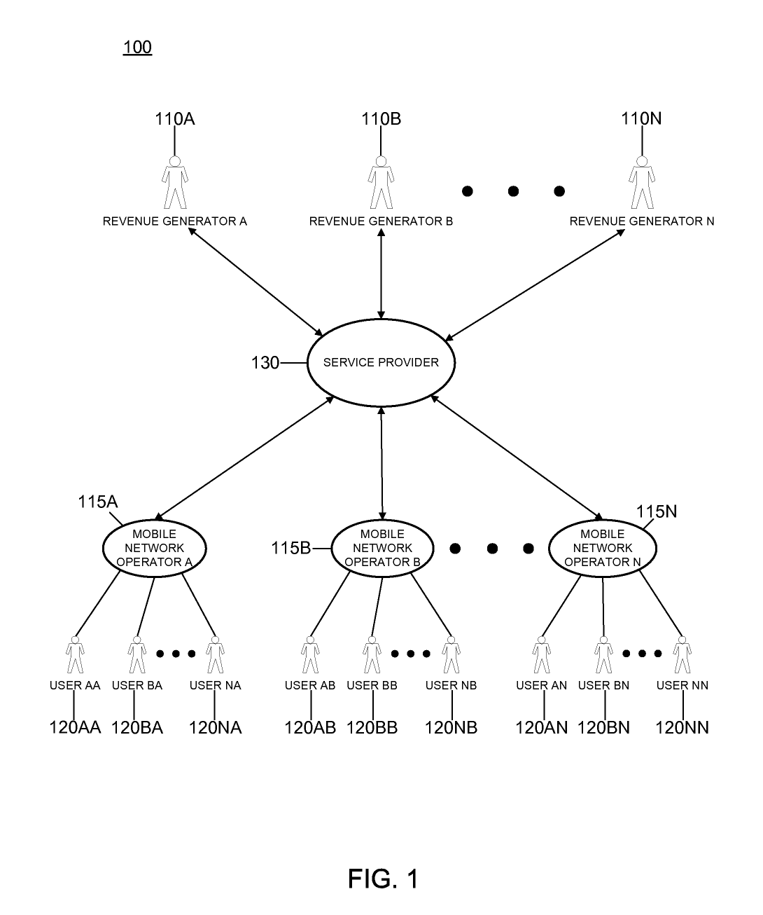

FIG. 1 provides a general overview of a system 100 for associating data items with context. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more revenue generators 110A-N, such as mobile advertisers, a service provider 130, such as a portal, one or more mobile network operators (“MNOs”) 115A-N, more commonly referred to as mobile carriers, or simply carriers, and one or more users 120AA-NN, such as mobile subscribers or consumers. The service provider 130 may implement an advertising campaign management system incorporating an auction based and/or non-auction based advertisement serving system.

The revenue generators 110A-N may pay the service provider 130 to serve, or display, advertisements of their goods or services, such as mobile advertisements, to the users 120AA-NN, such as over mobile messaging, mobile web, the Internet, or generally any venue for displaying advertisements. The advertisements may include sponsored listings, banners ads, popup advertisements, mobile messaging advertisements, or generally any way of attracting the users 120AA-NN to the web site or mobile site of the revenue generators 110A-N. The users 120AA-NN may utilize the services of the service provider 130 through web applications, mobile applications, such as mobile messaging applications, or standalone applications.

The service provider 130 may maintain a mobile portal and/or a web portal, such as a search site, where the service provider 130 may display advertisements of the revenue generators 110A-N to the users 120AA-NN. In the case of a mobile portal, the service provider 130 may share revenue with the mobile network operators MNOs 115A-N of the users 120AA-NN for displaying advertisements of the revenue generators 110A-N via their mobile networks. Alternatively or in addition the service provider 130 may share revenue with individual publishers for displaying advertisements of the revenue generators 110A-N on their mobile and/or web sites.

The MNOs 115A-N may provide a mobile network to the users 120AA-NN which may provide a variety of services to the users 120AA-NN, such as the ability to send and receive phone calls, send and receive mobile messages, to access the internet and/or the mobile web, or generally any service that may be implemented on a mobile device. The MNOs 115A-N may store data describing the users 120AA-NN, such as billing addresses, call histories, messaging histories, or generally any data regarding the users 120AA-NN that may be available to the MNOs 115A-N.

The service provider 130 may provide an application programming interface (“API”) to the MNOs 115A-N to allow the MNOs 115A-N to access the mobile search and mobile advertising services of the service provider 130. The MNOs 115A-N may make a call to the API to retrieve search results or mobile advertisements from the service provider 130.

The amount the revenue generators 110A-N may pay the service provider 130 for displaying advertisements may be based on one or more factors. These factors may include impressions, click throughs, conversions, and/or generally any metric relating to the advertisement and/or the behavior of the users 120AA-NN. The impressions may refer to the number of times an advertisement may have been displayed to the users 120AA-NN. The click throughs may refer to the number of times the users 120AA-NN may have clicked through an advertisement to a web site, mobile web site or mobile landing page of one of the revenue generators 110A-N, such as the revenue generator A 110A. The conversions may refer to the number of times a desired action was taken by the users 120AA-NN after clicking though to a web site of the revenue generator A 110A. The desired actions may include submitting a sales lead, making a purchase, viewing a key page of the site, downloading a whitepaper, and/or any other measurable action. If the desired action is making a purchase, then the revenue generator A 110A may pay the service provider 130 a percentage of the purchase.

The users 120AA-NN may also be consumers of goods or services who may be searching for a business, such as the business of one of the revenue generators 110A-N. The users 120AA-NN may be associated with one another via a social relation to one or more of the other users 120AA-NN. The social relation may be an explicit relationship, such as a relationship coded in a social network. Alternatively or in addition the social relation may be an implicit, implied, or inferred relationship, such as a relationship based on the actual number, frequency, length, or subject matter of contacts between users. The social relation may associate the users 120AA-NN who share a common interest. Alternatively or in addition the users 120AA-NN may be linked based on shared demographics. For example, all of the users 120AA-NN of the same age range, and/or gender, may be associated together.

Alternatively or in addition the users 120AA-NN may be machines or other servers, such as the third party server 250. The users 120AA-NN may need a user identifier or identification (“user ID”) to access the services of the service provider 130. In order to obtain a user ID the users 120AA-NN may need to supply information describing themselves to the service provider 130, such as the location, gender, or age of the users 120AA-NN, or generally any information that may be required for the users 120AA-NN to utilize the services provided by the service provider 130.

The service provider 130 may collect user behavior data from the users 120AA-NN, such as queries searched for by the users 120AA-NN, links clicked on by the users 120AA-NN and/or any user interactions with the services provided by the service provider 130. The service provider 130 may associate each piece of user behavior data with one or more contextual attributes. The contextual attributes may associate a subject matter or other keyword that designates an interest, activity or association of the user with that subject, topic or real-world object. The contextual attributes may describe the context at the time the users 120AA-NN generated the user behavior data. Alternatively or in addition the contextual attributes may be relative to other users or other queries. The contextual attributes may include a spatial attribute, a temporal attribute, a topical attribute, and a social attribute. The spatial attribute may describe the location of the user AA 120AA. The temporal attribute may describe the time when the user AA 120A interacted with the service provider 130. The topical attribute may describe the topics that the user AA 120AA has recently showed interest in. Alternatively or in addition the topical attribute may represent the subject matter of the query. The social attribute may describe the topics that the users 120AA-NN in a social relationship with the user AA 120AA have shown interest in. Alternatively or in addition the social attribute may represent an association or relation of the user with other users.

The service provider 130 may receive a search request from a user AA 120AA and provide contextually relevant search results and/or advertisements to the user AA 120AA. Contextually relevant data may be determined by analyzing user behavior data sharing the same contextual attributes as the current search query. The user behavior data sharing the same contextual attributes as the current search query may be used to determine which search results and/or advertisements the user AA 120AA may be most likely to click on. The search results and/or advertisements the user AA 120AA may be most likely to click on may be the most relevant search results and/or advertisements.

In the system 100, the revenue generators 110A-N may interact with the service provider 130, such as via a web application. The revenue generators 110A-N may send information, such as billing, website or mobile site and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application.

The users 120AA-NN may also interact individually with the service provider 130, through the mobile network operators 115A-N, such as via a mobile phone or any mobile device capable of communicating with the mobile network operators 115A-N. The users 120AA-NN may interact with the service provider 130 via a mobile web based application, a mobile standalone application, or any application capable of running on a mobile device. The service provider 130 may communicate data to the revenue generators 110A-N over a network and to the users 120AA-NN over a network via the MNOs 115A-N. The following examples may refer to a revenue generator A 110A as an online advertiser or mobile advertiser; however the system 100 may apply to any revenue generators 110A-N who may wish to serve advertisements over mobile devices.

A revenue generator A 110A who is an advertiser may maintain one or more accounts with the service provider 130. For each account the revenue generator A 110A may maintain one or more campaigns. For each campaign the revenue generator A 110A may maintain one or more listings. A listing may include a keyword, an advertisement title, an advertisement description, a bid amount and a network address, if any, such as a uniform resource locator (“URL”). A listing may represent an association between a keyword and an advertisement.

Alternatively or in addition the listing may be associated with a context descriptor. The context descriptor may describe a context surrounding a user AA 120AA when the user AA 120AA searches for the query. The context descriptor may include one or more attributes, such as a spatial attribute, a temporal attribute, a social attribute or a topical attribute. The spatial attribute may describe the location of the user AA 120AA when the user AA 120AA searches for the query. The temporal attribute may describe a time, or time of day, when the user AA 120AA searches for the query. The social attribute may describe an item of interest to user 120BB-N within a social relation of the user AA 120AA searching for the query. The topical attribute may describe a topical interest of the user AA 120AA searching for the query. A revenue generator A 110A may associate different versions of the advertisements for different contexts. For example, the revenue generator A 110A may wish to associate a different advertisement with a query depending on whether the user AA 120AA searches for the query in the evening or in the morning.

The keywords may represent one or more search terms that the revenue generator A 110A wishes to associate with their advertisement. The advertisement title may represent the data the revenue generator A 110A wishes to be displayed to a user AA 120AA. The network address may represent the link the revenue generator A 110A wishes a user AA 120AA to be directed to upon clicking on the advertisement of the revenue generator A 110A, such as the home page of the revenue generator A 110A. The bid amount may represent a maximum amount the revenue generator A 110A may be willing to pay each time a user AA 120AA may click on the advertisement of the revenue generator A 110A or each time the advertisement of the revenue generator A 110A may be shown to a user AA 120AA, such as in a mobile message. More detail regarding the aspects of mobile advertising systems, as well as their structure, function and operation, can be found in commonly owned U.S. patent application Ser. No. 11/712,276, filed on Feb. 28, 2007, entitled, “SYSTEM FOR SERVING ADVERTISEMENTS OVER MOBILE DEVICES”, which is hereby incorporated herein by reference in its entirety. The systems and methods herein associated with mobile advertising systems may be practiced in combination with methods and systems described in the above-identified patent application incorporated by reference.

In operation, the user AA 120AA may search for a query via a search service provided by the service provider 130. The service provider 130 may determine the contextual attributes at the time the user AA 120AA performs the search. The service provider 130 may retrieve historical user behavior data, such as historical user click data, sharing the same contextual attributes as the search of the user AA 120AA. The historical user click data may be represented by a model of click data of users 120AA-NN sharing the same contextual attributes as the user AA 120AA. The model may take the query searched for by the user AA 120AA as an input and may output the search results and/or advertisements most relevant to the user AA 120AA. Alternatively the model may take the query search for by the user AA 120AA and the contextual attributes as inputs.

More detail regarding the aspects of auction-based systems, as well as the structure, function and operation of the service provider 130, as mentioned above, can be found in commonly owned U.S. patent application Ser. No. 10/625,082, filed on Jul. 22, 2003, entitled, “TERM-BASED CONCEPT MARKET”; U.S. patent application Ser. No. 10/625,000, file on Jul. 22, 2003, entitled, “CONCEPT VALUATION IN A TERM-BASED CONCEPT MARKET” filed on Jul. 22, 2003; U.S. patent application Ser. No. 10/625,001, filed on Jul. 22, 2003, entitled, “TERM-BASED CONCEPT INSTRUMENTS”; and U.S. patent application Ser. No. 11/489,386, filed on Jul. 18, 2006, entitled, “ARCHITECTURE FOR AN ADVERTISEMENT DELIVERY SYSTEM,” all of which are hereby incorporated herein by reference in their entirety. The systems and methods herein associated with ad campaign management may be practiced in combination with methods and systems described in the above-identified patent applications incorporated by reference.

Furthermore, the service provider 130 may generate reports based on the data collected from the users 120AA-NN and communicate the reports to the revenue generators 110A-N to assist the revenue generators 110A-N in measuring the effectiveness of their advertising. The reports may indicate the number of times the users 120AA-NN viewed a mobile advertisement of the revenue generators 110A-N, the number of times a mobile advertisement of the revenue generators 110A-N was clicked on by the users 120AA-NN, the contextual attributes of the users 120AA-NN, or generally any information useful to the revenue generators 110A-N. There may be a separate report for each MNO 115A-N the advertisement of the revenue generator A 110A was displayed on. Alternatively or in addition the reports may be segmented based on one or more of the contextual attributes. The reports may also generally indicate any data that may assist the revenue generators 110A-N in measuring the effectiveness of their mobile advertising campaigns.

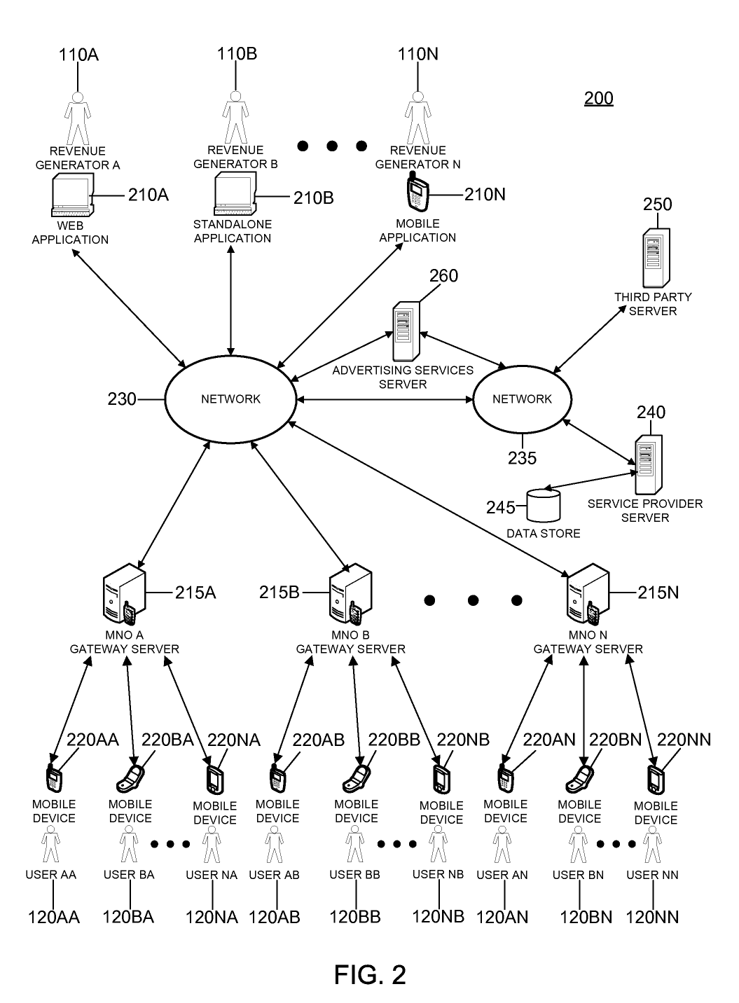

FIG. 2 provides a simplified view of a network environment implementing a system 200 for associating data items with context. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 210A-N, which may be collectively or individually referred to as client applications of the revenue generators 110A-N. The system 200 may also include one or more mobile applications, such as mobile messaging applications and/or mobile browsers, which may be running on one or more mobile devices 220AA-NN. The system 200 may also include one or more MNO gateway servers 215A-N, a network 230, a network 235, the service provider server 240, a third party server 250, and an advertising services server 260.

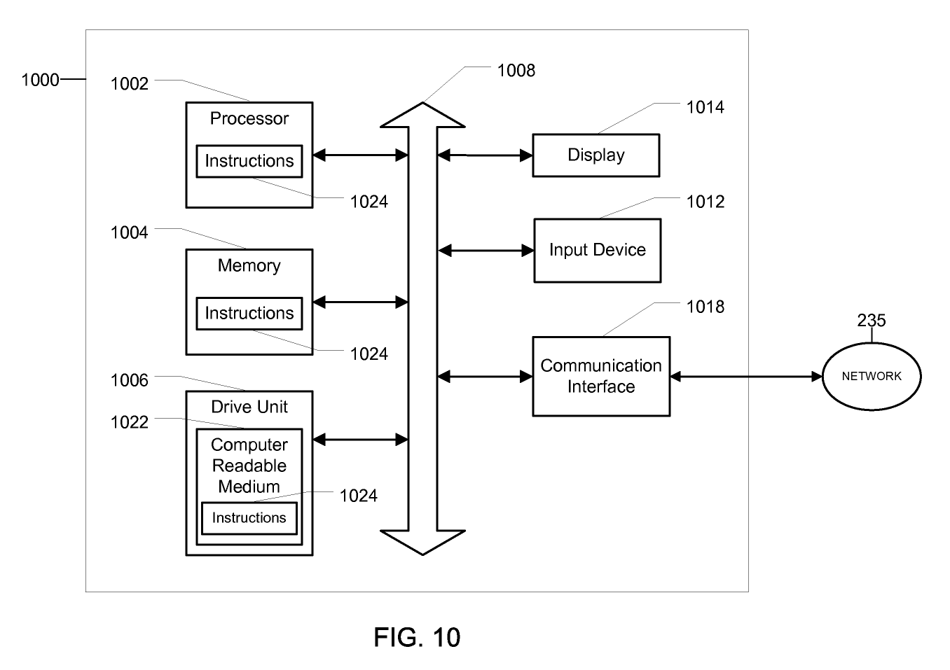

Some or all of the advertisement services server 260, service provider server 240, and third-party server 250 may be in communication with each other by way of network 235 and may be the system or components described below in FIG. 10. The advertisement services server 260, third-party server 250 and service provider server 240 may each represent multiple linked computing devices. Multiple distinct third party servers, such as the third-party server 250, may be included in the system 200. The third-party server 250 may be an MNO gateway server 215A-N or a server associated with, or in communication with an MNO gateway server 215A-N.

The networks 230, 235 may include wide area networks (“WAN”), such as the internet, mobile networks, local area networks (“LAN”), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235, through the web applications, standalone applications or mobile applications 210A-N.

The users 120AA-NN may use a mobile application running on a mobile device 220AA-220NN, such as a mobile web browser, to communicate with the service provider server 240, via the MNO gateway servers 215A-N and the networks 230, 235. The service provider server 240 may communicate to the users 120AA-NN via the networks 230, 235 and the MNO gateway servers 215A-N, through the mobile devices 220AA-NN.

The web applications, standalone applications, mobile applications and mobile devices 210A-N, 220AA-NN may be connected to the network 230 in any configuration that supports data transfer. This may include a data connection to the network 230 that may be wired or wireless. Any of the web applications, standalone applications and mobile applications 210A-N, may individually be referred to as a client application. The web application 210A may run on any platform that supports web content, such as a web browser or a computer, a mobile phone, personal digital assistant (“PDA”), pager, network-enabled television, digital video recorder, such as TIVO®, automobile and/or any appliance capable of data communications.

The standalone applications 210B may run on a machine that may have a processor, memory, a display, a user interface and a communication interface. The processor may be operatively connected to the memory, display and the interfaces and may perform tasks at the request of the standalone application 210B or the underlying operating system. The memory may be capable of storing data. The display may be operatively connected to the memory and the processor and may be capable of displaying information to the revenue generator B 110B. The user interface may be operatively connected to the memory, the processor, and the display and may be capable of interacting with a revenue generator B 110B. The communication interface may be operatively connected to the memory, and the processor, and may be capable of communicating through the networks 230, 235 with the service provider server 240, third party server 250 and advertising services server 260. The standalone application 210B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile application 210N may run on any mobile device which may have a data connection. The mobile applications 210N may be a web application 210A, a standalone application 210B, a mobile messaging application, a mobile browser, or a microbrowser. The mobile devices 220AA-NN may be one of a broad range of electronic devices which may include mobile phones, PDAs, and laptops and notebook computers. The mobile devices 220AA-NN may have a reduced feature set, such as a smaller keyboard and/or screen, and may be incapable of supporting a traditional web search.

The data connection of the mobile devices 220AA-NN may be a cellular connection, such as a GSM/GPRS/WCDMA connection, a wireless data connection, an internet connection, an infra-red connection, a Bluetooth connection, or any other connection capable of transmitting data. The data connection may be used to connect directly to the network 230, or to connect to the network 230 through the MNO gateway servers 215A-N.

The MNO gateway servers 215A-N may control the access the mobile devices 220AA-NN may have to the network. The MNO gateway servers 215A-N may also control the technology supporting the respective mobile devices 220AA-NN. This may affect aspects of the user experience, such as signal strength and availability, speed and billing mechanisms. For example, the MNO gateway server A 215A may only allow the users 120AA-NA access to content provided by partners of the MNO A 115A. Furthermore, the MNO gateway servers 215A-N may only allow users 120AA-NN access to data in a specific format, such as WML, XHTML, NTT DOCOMO IMODE HTML, or cHTML. Alternatively or in addition, the mobile devices 220AA-NN may only support one of the aforementioned formats.

The service provider server 240 may include one or more of the following: an application server, a data source, such as a database server, a middleware server, and an advertising services server. One middleware server may be a mobile commerce platform, such as the YAHOO! SUSHI platform, which may properly encode data, such as mobile pages or mobile advertisements, to the formats specific to the MNO gateway servers 215A-N. The service provider server 240 may co-exist on one machine or may be running in a distributed configuration on one or more machines. The service provider server 240 may collectively be referred to as the server. The service provider server 240 may receive requests from the users 120AA-NN and the revenue generators 110A-N and may serve mobile pages to the users 120AA-NN and web pages and/or mobile pages to the revenue generators 110A-N based on their requests.

The third party server 250 may include one or more of the following: an application server, a data source, such as a database server, a middleware server, and an advertising services server. The third party server 250 may co-exist on one machine or may be running in a distributed configuration on one or more machines. The advertising services server 260 may provide a platform for the inclusion of advertisements in pages, such as web pages or mobile pages. The advertisement services server 260 may be used for providing mobile advertisements that may be displayed to the users 120AA-NN.

The service provider server 240, the third party server 250 and the advertising services server 260 may be one or more computing devices of various kinds, such as the computing device in FIG. 10. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (“TCP/IP”) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120AA-NN and the revenue generators 110A-N. The advertising services server may provide a platform for the inclusion of advertisements in pages, such as web pages. The advertising services server 260 may also exist independent of the service provider server 240 and the third party server 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (“LAN”), a wide area network (“WAN”), a direct connection such as through a Universal Serial Bus (“USB”) port, and the like, and may include the set of interconnected networks that make up the Internet. The networks 230, 235 may include any communication method by which information may travel between computing devices.

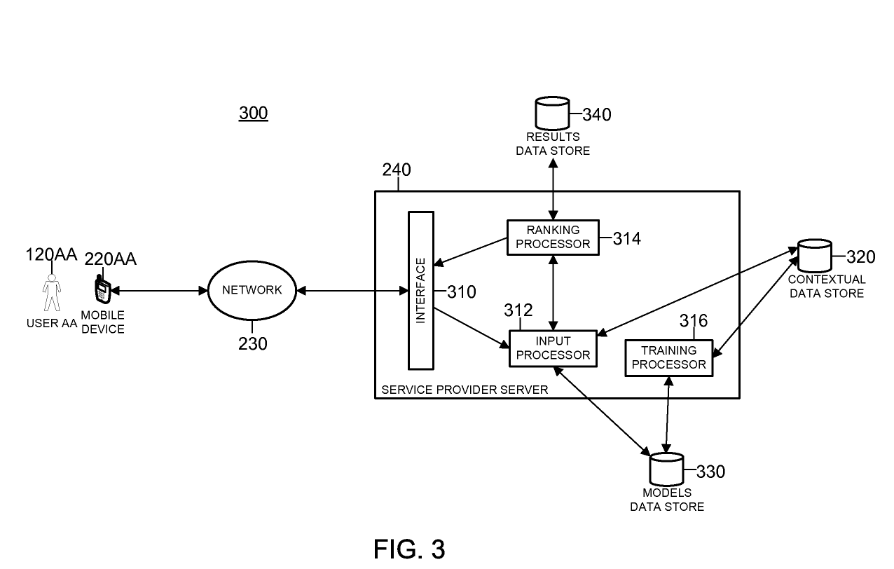

FIG. 3 illustrates a block diagram of an implementation 300 of the system of FIG. 1 or other systems for associating data items with context. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The implementation 300 may include a user AA 120AA, a mobile device 220AA, a network 230, a service provider server 240, a contextual data store 320, a models data store 330, and a results data store 340. The service provider server 240 may include an interface 310, an input processor 312, a training processor 316 and a ranking processor 314. The interface 310 may allow the service provider server 240 to communicate with the mobile device 220AA over the network 230. The processors 312, 314, 316 may be located on the same physical machine or, or may be running across several machines in a distributed environment.

In operation, the user AA 120AA may interact with a service of the service provider server 240 via the mobile device 220AA over the network 230. The mobile device 220AA may communicate with the service provider server 240 via the interface 310. The interface 310 may receive an indication of an action performed by the user AA 120AA, such as when the user AA 120AA clicks on a search result after searching for a query. The interface 310 may communicate the action to the input processor 312. The input processor 312 may determine the contextual attributes associated with the action, such as a spatial attribute, a temporal attribute, a topical attribute and a social attribute. The input processor 312 may determine the spatial attribute based on a positioning system implemented by the mobile device 220AA, and/or based on a network address of the mobile device 220AA. The input processor 312 may store an association between the contextual attributes, the query searched for by the user AA 120AA, and the search result clicked on by the user AA 120AA in the contextual data store 320. The input processor 312 may then provide a forwarding network address associated with the search result clicked on to the mobile device of the user AA 120AA.

The training processor 316 may generate one or more models representing the behavior of users 120AA-NN within a given context based on the data stored in the contextual data store 320. The training processor 316 may create a model for each context represented in the contextual data store 320, or may create a model for the most commonly represented contexts in the contextual data store 320. The training processor 316 may analyze the historical click data of the users 120AA-NN within a given context to generate a model for each context capable of determining the most relevant search results and/or advertisements for a user AA 120AA within the context.

The user AA 120AA may perform a search for a query via a service provided by the service provider server 240. The service provider server 240 may receive the search query via the interface 310. The interface 310 may communicate the search query to the input processor 312. The input processor 312 may determine the context in which the search query was performed. The input processor 312 may retrieve the model from the models data store 330 representing the context of the user AA 120AA. The input processor 312 may provide the model and the search query to the ranking processor 314. The ranking processor 314 may use the model to retrieve the search results in the results data store 340 which are most relevant to the context of the user AA 120AA. Alternatively or in addition the ranking processor 314 may use the model to retrieve advertisements relevant to the context of the user AA 120AA from the results data store 340. The ranking processor 314 may provide the search results most relevant to the context of the user AA 120AA to the interface 310. The number of search results provided to the interface 310 may be dependent on the display capacity of the mobile device 220AA of the user AA 120AA. The interface 310 may provide the results to the mobile device 220AA via the network 230.

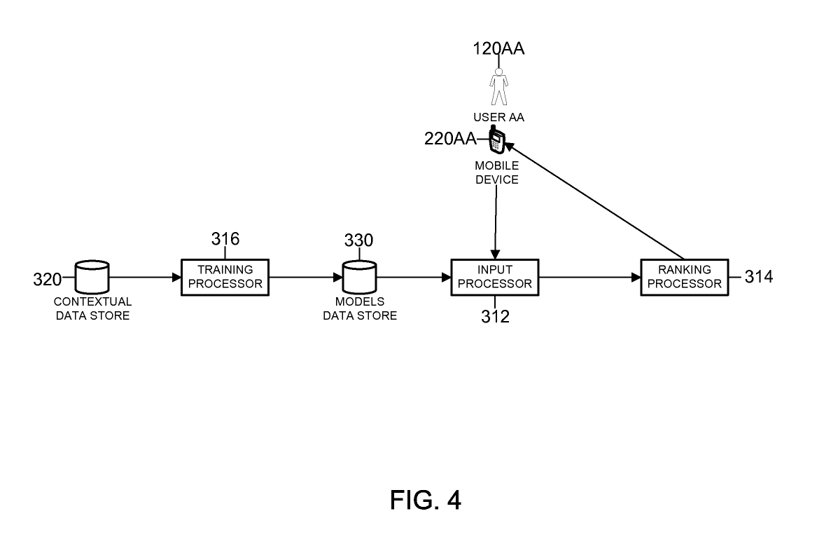

FIG. 4 illustrates a block diagram of a workflow of the system of FIG. 1 or other systems for associating data items with context. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The workflow 300 of the system 100 may include the contextual data store 320, the training processor 316, the models data store 330, the input processor 312, the ranking processor 314, the user AA 120AA, and the mobile device 220AA. The workflow 100 of the system 100 may start with the contextual data store 320. The contextual data store 320 may include data describing the actions of the users 120AA-NN, such as user click data. Each action may be associated with one or more contextual attributes, such as a spatial attribute, a temporal attribute, a social attribute, and a topical attribute.

The data from the contextual data store 320 may be provided to the training processor 316. The training processor 316 may analyze the data in the contextual data store 320 to generate a model for each of the contexts represented in the contextual data store. The models may reflect the historical behavior of the users 120AA-NN within the context represented by each model. The training processor 316 may then store the models in the models data store 330. A model may be retrieved from the models data store 330 by the input processor 312 when a user AA 120AA searches for a search query via the mobile device 220AA. The input processor 312 may determine the context the search query was performed in, and may retrieve the model corresponding to the context. The input processor 312 may provide the model retrieved from the models data store 330, and the query searched for by the user AA 120AA, to the ranking processor 314.

The ranking processor 314 may use the model to select the search results and or advertisements most relevant to the context of the user AA 120AA determined by the input processor 312 for the search query. The ranking processor 314 may rank the search results based on their relevancy, in the model, to the search query and may provide the ranked search results to the mobile device 220AA of the user AA 120AA.

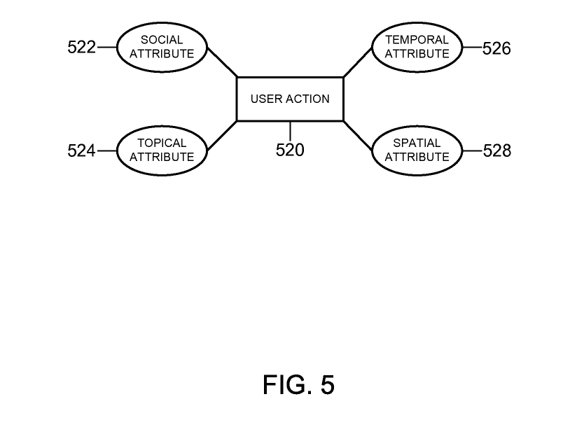

FIG. 5 illustrates exemplary contextual attributes associated with a user click action in the system of FIG. 1, or other systems for associating data items with context. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 100 may determine the context of a user action 520 when the user AA 120AA performs an action. An association between the context and the user action 520 may be stored in the contextual data store 320. The context of a user action 520 may be based on a social attribute 522, a topical attribute 524, a temporal attribute 526, and a local attribute 528. In the case of a user action 520 consisting of a user AA 120AA clicking on a search result, the system 100 may also store an association with the search query which generated the search result.

The social attribute 522 of the user action 520 may describe the recent actions of the other users 120BB-NN associated with the user AA 120AA, such as users 120BB-NN associated with the user AA 120AA through a social relation. The social relations of the user AA 120AA may be determined based on a service offered by the service provider 130 or by a third party server 250. Alternatively or in addition the social attribute 522 may describe the behavior of the users 120BB-NN sharing a social relation with the user AA 120AA. The behavior of the users 120BB-NN may include expressing interest in an item, such as by reading a news article, clicking on search results, visiting places, buying items, connecting with other people, participating in groups and/or group activities, or generally expressing interest in any topical, spatial, or social issues and items. The social attribute 522 may be determined by analyzing the click data of the users 120BB-NN associated with the user AA 120AA.

The topical attribute 524 of the user action 520 may describe the recent actions of the user AA 120AA. The recent actions of the user AA 120AA may include items recently of interest to the user AA 120AA, such as news articles read by the user AA 120AA, search results clicked on by the user AA 120AA, or generally any items the user AA 120AA previously expressed interest in. The topical attribute 524 may be determined by analyzing the click data of the user AA 120AA.

The social attributes 522 and the topical attributes 524 may be selected from a group of categories. The categories may generally relate to topics of interests to the users 120AA-NN, such as sports, news, music, video, or generally any topic of interest to users 120AA-NN. The topics may be determined based on metrics measuring general topics of interest to the users 120AA-NN. Alternatively or in addition the categories may contain more specific sub-categories. For example, the category of sports may have subcategories such as football, baseball, basketball, hockey, or generally any sport that may be of interest to the users 120AA-NN. The system 100 may analyze the content of the pages visited by the users 120AA-NN to determine which categories the website relates to. Alternatively or in addition a third party server 250 may provide categories for each web site, or may determine the category a website relates to.

The temporal attribute 526 of the user action 520 may be the time the user AA 120AA performed the user action 520. For example, in the case of a click action, the temporal attribute 526 may be the time the user AA 120AA clicked on a link. The temporal attribute 526 may be determined based on a timestamp associated with the action performed by the user AA 120AA.

The spatial attribute 528 of a user action 520 may be the location of the user AA 120AA when the user AA 120AA performs the user action 520. The location of the user AA 120AA may be determined by a positioning system implemented by the mobile device 220AA, such as a global positioning system, a cell phone tower triangulation system, a wireless internet signal triangulation system, or generally any system capable of determining the location of a user AA 120A. Alternatively or in addition the location of the user AA 120AA may be determined based on the network address associated with the mobile device 220AA, may be determined based on the content of the search query, or generally maybe determined based on other analytical methods. Alternatively or in addition the location of the user AA 120AA may be determined based on a known location of a user who is known to be within a close proximity of the user AA 120AA.

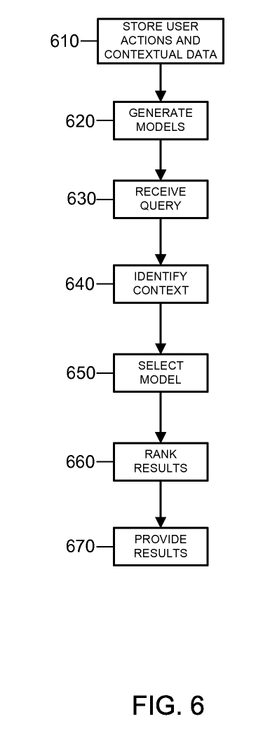

FIG. 6 is a flowchart illustrating operations of associating data items with context in the system of FIG. 1, or other systems for associating data items with context. At block 610 the service provider 130 stores data describing user actions 520, and the contextual data 522, 524, 526, 528 associated with each user action 520, in the contextual data store 320. The service provider 130 may store data describing the user actions 520 over a period of time before generating the models. Alternatively the service provider 130 may add data to the contextual data store 320 until the contextual data store 320 contains enough data to generate reliable models. At block 620 the training processor 316 generates models for each of the contexts stored in the contextual data store 320. For example, a model of a given context may contain all of the user action data associated with the context. The models may be stored in the models data store 330. Alternatively or in addition the system 100 may generate models for contexts that only share one of the contextual attributes 522, 524, 526, 528 in common, such as the spatial attribute 528.

At block 630 the system 100 may receive a search query from one of the users 120AA-NN, such as the user AA 120AA. At block 640 the system 100 may identify the contextual attributes 522, 524, 526, 528 associated with the search query received from the user AA 120AA. At block 650 the system 100 may select a model from the models data store 330 that corresponds to the contextual attributes of the search query identified in block 640. The selected data model may correlate to one or more of the contextual attributes associated with the search query. At block 660 the ranking processor 314 may use the selected model to rank the search results retrieved for the search query. The selected model may allow the ranking processor 314 to incorporate the context of the search query into the ranking of the search results. The search results may be paid advertisements listings, unpaid search listings, or a combination of paid advertisement listings and unpaid search listings. At block 670 the service provider 130 may provide the ranked results to the user AA 120AA.

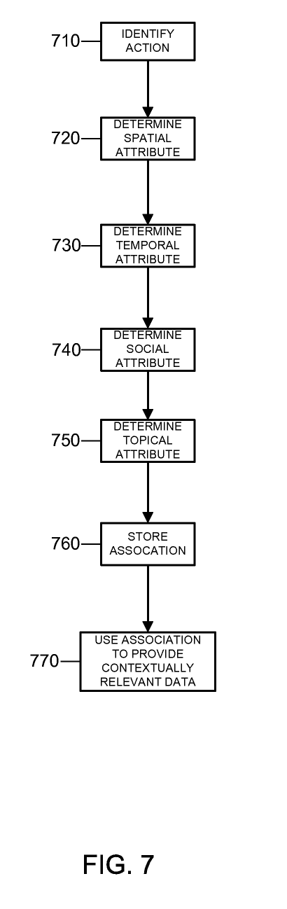

FIG. 7 is a flowchart illustrating operations of building a contextual data store in the system of FIG. 1, or other systems for associating data items with context. At block 710 the service provider 130 identifies an action of one of the users 120AA-NN, such as the user AA 120AA clicking on a search result. At block 720 the service provider 130 determines the spatial attribute 528 of the user action 520. The spatial attribute 528 may describe the location of the user AA 120AA. The location of the user AA 120AA may be determined by a positioning system implemented by the mobile device 220AA of the user AA 120AA, or by analyzing data associated with the mobile device 220AA, such as the network address of the mobile device 220AA. At block 730 the service provider 130 may determine the temporal attribute 526 of the user action 520. The temporal attribute 526 may describe the time when the user AA 120AA performed the action.

At block 740 the service provider 130 may determine the social attribute 522 of the user action 520. The social attribute 522 may describe the interests of the users 120BB-NN associated with the user AA 120AA, such as through a social relation. At block 750 the service provider 130 may determine the topical attribute 524 of the user action 520. The topical attribute 524 may describe the topics the user AA 120AA has recently expressed interest in, such as a category describing web sites recently visited by the user AA 120AA.

At block 760 the service provider 130 may store an association between the user action 520, in this case the search result clicked on by the user AA 120AA, the spatial attribute 528, the temporal attribute 526, the social attribute 522 and the topical attribute 524 in the contextual data store 320. In the case of a user action 520 including a user AA 120AA clicking on a search result after searching for a search query, the service provider 130 may also store an association with the search query. At block 770 the service provider 130 may use the stored association to provide contextually relevant data. For example, the service provider 130 may use the stored association to determine a search result contextually relevant to a search query.

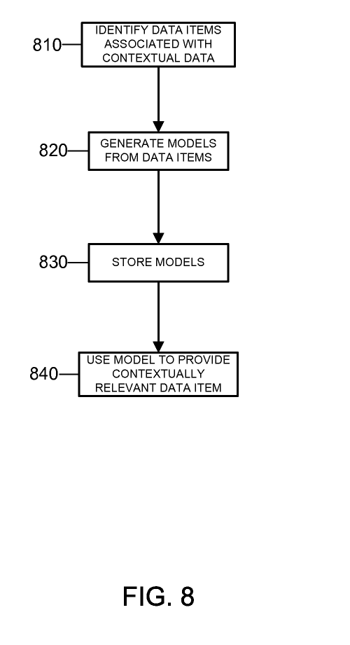

FIG. 8 is a flowchart illustrating operations of generating contextual models in the system of FIG. 1, or other systems for associating data items with context. At block 810 the service provider 130 may determine data items associated with contextual data, such as user actions 520 associated with contextual attributes 522, 524, 526, 528 stored in the contextual data store 320. At block 820 the training processor 316 may generate a model for each of the contexts represented in the contextual data store 320. For example, a model may consist of the data describing the user actions 520 associated with the context represented by the model. At block 830 the service provider 130 may store the models in the models data store 330. At block 840 the service provider 130 may use a model to provide a contextually relevant data item, such a contextually relevant search result. In the case of the contextually relevant search result, a model sharing a context with a query search may take the query search as an input and may output an indication of the search results contextually relevant to the query search.

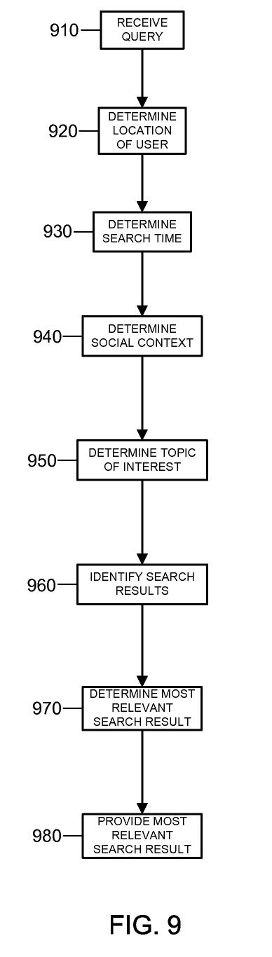

FIG. 9 is a flowchart illustrating operations of providing contextually relevant search results in the system of FIG. 1 or other systems for associating data items with context. At block 910 the service provider 130 may receive a search query from one of the users 120AA-NN, such as the user AA 120AA. At block 920 the service provider 130 may determine the location of the user AA 120AA. The location of the user AA 120AA may be retrieved from a positioning system implemented by the mobile device 220AA of the user AA 120AA. Alternatively or in addition the location of the user may be determined based on the network address associated with the mobile device 220AA of the user AA 120AA or by other analytical methods. At block 930 the service provider 130 may determine the time the search query was received from the user AA 120AA, such as through a timestamp associated with receiving the search query. At block 940 the service provider 130 may determine a social context of the search query. The service provider may determine any social networks the user AA 120AA is associated with and/or any demographic groups the user AA 120AA belongs to. The service provider may determine any social relationships of the user AA 120AA and/or any demographic groups the user AA 120AA belongs to. The service provider 130 may then determine the topics recently searched for by other users 120BB-NN associated with the user AA 120AA.

At block 950 the service provider 130 may determine the recent topics of interests of the user AA 120AA. The recent topics of interest may correspond to the links recently clicked on by the user AA 120AA. At block 960 the service provider 130 may identify the search results in that are associated with the determined contextual attributes. At block 970 the service provider 130 may determine the most relevant search result. The most relevant search result may be the search result which was most frequently clicked on after performing a search sharing the contextual attributes of the current search. Alternatively or in addition the most relevant search result may be based on one or more other factors, such as in the case of advertisements the amount bid on the advertisement. At block 980 the system 100 may provide the most relevant search result to the mobile device 220AA of the user AA 120AA. Alternatively or in addition the number of most relevant search results provided to the mobile device 220AA may depend on the number of search results the mobile device 220AA is capable of displaying at a time.

FIG. 10 illustrates a general computer system 1000, which may represent a service provider server 240, a third party server 250, an advertising services server 260, a training processor 316, an input processor 312, a ranking processor 314, or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 1000 may include a set of instructions 1024 that may be executed to cause the computer system 1000 to perform any one or more of the methods or computer based functions disclosed herein. The computer system 1000 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1000 may also be implemented as or incorporated into various devices, such as a personal computer (“PC”), a tablet PC, a set-top box (“STB”), a personal digital assistant (“PDA”), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1024 (sequential or otherwise) that specify actions to be taken by that machine. In a particular embodiment, the computer system 1000 may be implemented using electronic devices that provide voice, video or data communication. Further, while a single computer system 1000 may be illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, such as, a central processing unit (“CPU”), a graphics processing unit (“GPU”), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may implement a software program, such as code generated manually (i.e., programmed).

The computer system 1000 may include a memory 1004 that can communicate via a bus 1008. The memory 1004 may be a main memory, a static memory, or a dynamic memory. The memory 1004 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1004 may include a cache or random access memory for the processor 1002. Alternatively or in addition, the memory 1004 may be separate from the processor 1002, such as a cache memory of a processor, the system memory, or other memory. The memory 1004 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1004 may be operable to store instructions 1024 executable by the processor 1002. The functions, acts or tasks illustrated in the figures or described herein may be performed by the programmed processor 1002 executing the instructions 1024 stored in the memory 1004. The functions, acts or tasks may be independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

The computer system 1000 may further include a display 1014, such as a liquid crystal display (“LCD”), an organic light emitting diode (“OLED”), a flat panel display, a solid state display, a cathode ray tube (“CRT”), a projector, a printer or other now known or later developed display device for outputting determined information. The display 1014 may act as an interface for the user to see the functioning of the processor 1002, or specifically as an interface with the software stored in the memory 1004 or in the drive unit 1006.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the system 1000.

The computer system 1000 may also include a disk or optical drive unit 1006. The disk drive unit 1006 may include a computer-readable medium 1022 in which one or more sets of instructions 1024, e.g. software, can be embedded. Further, the instructions 1024 may perform one or more of the methods or logic as described herein. The instructions 1024 may reside completely, or at least partially, within the memory 1004 and/or within the processor 1002 during execution by the computer system 1000. The memory 1004 and the processor 1002 also may include computer-readable media as discussed above.

The present disclosure contemplates a computer-readable medium 1022 that includes instructions 1024 or receives and executes instructions 1024 responsive to a propagated signal; so that a device connected to a network 235 may communicate voice, video, audio, images or any other data over the network 235. The instructions 1024 may be implemented with hardware, software and/or firmware, or any combination thereof. Further, the instructions 1024 may be transmitted or received over the network 235 via a communication interface 1018. The communication interface 1018 may be a part of the processor 1002 or may be a separate component. The communication interface 1018 may be created in software or may be a physical connection in hardware. The communication interface 1018 may be configured to connect with a network 235, external media, the display 1014, or any other components in system 1000, or combinations thereof. The connection with the network 235 may be a physical connection, such as a wired Ethernet connection or may be established wirelessly as discussed below. Likewise, the additional connections with other components of the system 1000 may be physical connections or may be established wirelessly. In the case of a service provider server 240, a third party server 250, an advertising services server 260, the servers may communicate with users 120AA-NN and the revenue generators 110A-N through the communication interface 1018.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 1022 may be a single medium, or the computer-readable medium 1022 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1022 may include a solid-state memory such as a memory card or other package that houses one or more non-volatile read-only memories. The computer-readable medium 1022 also may be a random access memory or other volatile re-writable memory. Additionally, the computer-readable medium 1022 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A computer implemented method of building a data store of contextually relevant data items, comprising:
identifying an action performed by a user;
determining a spatial attribute of the action, the spatial attribute relating to a location of the user;
determining a temporal attribute of the action, the temporal attribute relating to a time when the action was performed;
determining a social attribute of the action, the social attribute relating to a social relation of the user;
determining a topical attribute of the action, the topical attribute relating to a topic of interest to the user;
storing an association between a descriptor of the action performed by the user, the spatial attribute of the action, the temporal attribute of the action, the social attribute of the action and the topical attribute of the action in a data store; and
using the stored association to provide a contextually relevant data item.

2. The computer implemented method of claim 1 wherein the action comprises a response of a user to a plurality of search results.

3. The computer implemented method of claim 2 wherein the plurality of search results are related to a query associated with the user.

4. The computer implemented method of claim 3 wherein storing an association between the action performed by the user, the spatial attribute of the action, the temporal attribute of the action, the social attribute of the action and the topical attribute of the action in a data store comprises storing an association between the response of the user, the query, the spatial attribute of the response, the temporal attribute of the response, the social attribute of the response and the topical attribute of the response in a data store.

5. The computer implemented method of claim 3 wherein the topic of interest to the user is determined based on a second query associated with the user.

6. The computer implemented method of claim 3 wherein the social context of the user is determined based on a second query associated with a second user, the second user being related to the user through a social relation.

7. The computer implemented method of claim 2 wherein the plurality of search results comprises a plurality of advertisements.

8. The computer implemented method of claim 2 wherein the action comprises the user clicking on a search result in the plurality of search results.

9. The computer implemented method of claim 2 wherein the action comprises of the user performing a desired response on a page referenced by a search result in the plurality of search results.

10. The computer implemented method of claim 1 wherein the location of the user is based on a known location of a second user, the second user being located within a known proximity of the user.

11. A computer implemented method of building contextual models out of contextually relevant data items, comprising:
identifying a plurality of data items, each data item associated with a spatial attribute, a temporal attribute, a social attribute and a topical attribute;
generating a plurality of contextual models, each contextual model comprising of the data items which share at least one of the spatial attribute, the temporal attribute, the social attribute or the topical attribute;
storing the plurality of contextual models in a data store; and
using a contextual model in the plurality of contextual models to provide a contextually relevant data item.

12. The computer implemented method of claim 11 wherein the plurality of data items comprises a plurality of search results.

13. The computer implemented method of claim 11 wherein each data item in the plurality of data items is further associated with a search query.

14. The computer implemented method of claim 11 wherein each contextual model comprises of the plurality of data items which share the spatial attribute, the temporal attribute, the social attribute, and the topical attribute.

15. The computer implemented method of claim 11 wherein the plurality of data items comprises a plurality of advertisements.

16. The computer implemented method of claim 11 wherein the spatial attribute is based on a known location of a second user, the second user being located within a known proximity of the user.

17. A system for building a data store of contextually relevant data items, comprising:
a memory to store an association between a descriptor of an action performed by a user, a spatial attribute of the action, a temporal attribute of the action, a social attribute of the action and a topical attribute of the action;
an interface operatively connected to the memory, the interface to provide a contextually relevant data item; and
a processor operatively connected to the memory and the interface, the processor for running instructions, wherein the processor identifies the action performed by the user, determines the spatial attribute of the action, the spatial attribute relating to a location of the user, determines the temporal attribute of the action, the temporal attribute relating to a time when the user performed the action, determines the social attribute of the action, the social attribute relating to a social relation of the user, determines the topical attribute of the action, the topical attribute relating to a topic of interest to the user, stores the association between the descriptor of the action performed by the user, the spatial attribute of the action, the temporal attribute of the action, the social attribute of the action and the topical attribute of the action in the memory, and uses the stored association to provide a contextually relevant data item via the interface.

18. The system of claim 17 wherein the processor determines the location of the user based on a known location of a second user, the second user being located within a known proximity of the user.

19. The system of claim 17 wherein the action comprises of a response of the user to a plurality of search results.

20. The system of claim 19 wherein the plurality of search results are related to a query associated with the user.

21. The system of claim 20 wherein the processor determines the topical interest of the user based on a second query associated with the user.

22. The system of claim 20 wherein the processor determines the social context of the user based on a second query associated with a second user, the second user being related to the user through a social relation.

23. The system of claim 19 wherein the plurality of search results comprises a plurality of advertisements.

24. The system of claim 19 wherein the action comprises the user clicking on a search result in the plurality of search results.

25. The system of claim 19 wherein the action comprises of the user performing a desired response on a page referenced by a search result in the plurality of search results.
